(19) United States
(12) Patent Application Publication
(10) Pub. No.: US 2023/0024586 A1
(43) Pub. Date: Jan. 26, 2023

(54) LEARNING DEVICE, LEARNING METHOD, AND RECORDING MEDIUM

(71) Applicant: NEC Corporation, Minato-ku, Tokyo (JP)

(72) Inventor: Go KANNO, Tokyo (JP)

(73) Assignee: NEC Corporation, Minato-ku ,Tokyo (JP)

(21) Appl. No.: 17/784,152

(22) PCT Filed: Dec. 25, 2019
(86) PCT No.: PCT/JP2019/050784

§ 371 Date: Jun. 10, 2022

(51) Int. Cl. G06V 10/774; G06V 10/764; G06V 10/776

(52) U.S. Cl. CPC G06V 10/774; G06V 10/764; G06V 10/776

(57) ABSTRACT

A learning device is configured to comprise a learning unit, an attention part detection unit, and a data generation unit in order to enhance estimation accuracy based on a learning model with respect to various kinds of data. The learning unit executes machine learning on the basis of first learning data and generates a learning model that classifies a category of the first learning data. The attention part detection unit classifies the category of the first learning data by using the generated learning model. When performing the classification, the attention part detection unit detects, in the first learning data, a part to which the learning model pays attention. The data generation unit generates second learning data obtained by processing the attention-paid part on the basis of the proportion of the attention-paid part matching a pre-determined attention determination part to which attention should be paid.

### TECHNICAL FIELD

The present invention relates to machine learning, and in particular relates to a technology for improving estimation accuracy by a learning model generated by machine learning.

### BACKGROUND ART

Data classification using a learning model generated by machine learning using deep learning has been widely used. For example, in machine learning for classification of images, a learning model is generated in which learning is performed with image data and a label indicating a target on the image as teaching data, and classification (meaning a category to be classified) of the target on the image is estimated using the generated learning model. As estimation of data classification using a learning model generated by machine learning is widely used, higher estimation accuracy is required. Therefore, a technology for generating a learning model capable of improving estimation accuracy has also been developed. As a technology for generating a highly accurate learning model, for example, a technology as in PTL 1 is disclosed.

The learning device of PTL 1 performs learning using image data selected based on a classification confidence, which is an index indicating a likelihood of classification for an image, when performing machine learning. PTL 1 describes that by performing machine learning using an image having a high classification confidence, it is possible to generate a highly accurate learning model while suppressing time required for generation of the learning model.

NPL 1 discloses a gradient-weighted class activation mapping (Grad-CAM) method, which is a technique for detecting a region where a learning model recognizes a classification target exists when the learning model estimates classification of an image. NPL 2 discloses a technology of generating a learning model by performing machine learning with signal data of an electrocardiogram and an emotion associated to the signal data as teaching data, and detecting a part recognized by the learning model as a characteristic part in the signal data by Grad-CAM method.

### CITATION LIST

### Patent Literature

[PTL 1] WO 2017/145960

### Non Patent Literature

[NPL 1] Ramprasaath R. Selvaraju, and five others, “Grad-CAM: Visual Explanations from Deep Networks via Gradient-based Localization”, [online], Mar. 21, 2017, [searched on Nov. 23, 2019], Internet <https://arxiv.org/pdf/1610.02391.pdf>
[NPL 2] Shigeki SHIMIZU, and five others, “Driver Emotion Estimation via Convolutional Neural Network with ECG”, Transactions of Society of Automotive Engineers of Japan, Society of Automotive Engineers of Japan, Mar. 15, 2019, Vol. 50, No. 2, p. 505-510

### SUMMARY OF INVENTION

### Technical Problem

However, the technology of PTL 1 is not sufficient in the following points. Since the machine learning device of PTL 1 performs learning by selectively using image data having a high classification confidence, an image having a low classification confidence is possibly not sufficiently reflected in the learning model. Therefore, with the learning model used by the learning device of PTL 1, when classification of image data similar to image data having a low classification confidence is estimated, there is a risk of failing to obtain sufficient estimation accuracy. NPL 1 and NPL 2 are related to a technology for detecting a part to which attention is paid by a learning model, and do not disclose a technology for generating a learning model capable of improving estimation accuracy.

In order to solve the above problem, an object of the present invention is to provide a learning device that generates a learning model capable of improving estimation accuracy for various data.

### Solution to Problem

In order to solve the above problem, a learning device of the present invention includes a learning unit, an attention part detection unit, and a data generation unit. The learning unit executes machine learning based on the first training data and generates a learning model for classifying a category of the first training data. The attention part detection unit classifies the category of the first training data using the generated learning model. When performing the classification, the attention part detection unit detects an attention part on the first training data to which the learning model pays attention. The data generation unit generates second training data in which an attention part is processed based on a rate at which the attention part matches a predetermined attention determination part to which attention is to be paid.

A learning method of the present invention includes executing machine learning based on first training data and generating a learning model for classifying a category of the first training data. The learning method of the present invention includes detecting an attention part on the first training data to which the learning model pays attention when classifying a category of the first training data by using the learning model. The learning method of the present invention includes generating second training data in which an attention part is processed based on a rate at which the attention part matches a predetermined attention determination part to which attention is to be paid.

A recording medium of the present invention records a computer program that causes a computer to execute processing. The computer program causes the computer to execute processing of executing machine learning based on first training data and generating a learning model for classifying a category of the first training data. The computer program causes the computer to execute processing of detecting an attention part on the first training data to which the learning model pays attention when classifying a category of the first training data by using the learning model. The computer program causes the computer to execute processing of generating second training data in which an attention part is processed based on a rate at which the attention part matches a predetermined attention determination part to which attention is to be paid.

### Advantageous Effects of Invention

According to the present invention, it is possible to obtain a learning model capable of improving estimation accuracy for various data.

### BRIEF DESCRIPTION OF DRAWINGS

FIG. 1A is a view illustrating a configuration of a first example embodiment of the present invention.

FIG. 1B is a view illustrating an operation flow in the first example embodiment of the present invention.

FIG. 2 is a view illustrating a configuration of a second example embodiment of the present invention.

FIG. 3 is a view illustrating a configuration of a learning device of the second example embodiment of the present invention.

FIG. 4 is a view illustrating a configuration of a terminal device of the second example embodiment of the present invention.

FIG. 5 is a view illustrating an operation flow in the second example embodiment of the present invention.

FIG. 6 is a view illustrating an example of an image used for machine learning in the second example embodiment of the present invention.

FIG. 7 is a view illustrating an example of an image in which marking is performed on an attention part in the second example embodiment of the present invention.

FIG. 8 is a view illustrating an example of an image in which a learning model schematically indicates an attention part in the second example embodiment of the present invention.

FIG. 9 is a view illustrating an example of an image in which a learning model schematically indicates an attention part in the second example embodiment of the present invention.

FIG. 10 is a view illustrating an example of a comparison image in the second example embodiment of the present invention.

FIG. 11 is a view illustrating an example of an image subjected to inactivation processing in the second example embodiment of the present invention.

FIG. 12 is a view illustrating an example of an image subjected to inactivation processing in the second example embodiment of the present invention.

FIG. 13 is a view illustrating a configuration of a third example embodiment of the present invention.

FIG. 14 is a view illustrating a configuration of a learning device of the third example embodiment of the present invention.

FIG. 15 is a view illustrating an operation flow of the learning device of the third example embodiment of the present invention.

FIG. 16 is a view illustrating an example of a user interface in the third example embodiment of the present invention.

FIG. 17 is a view illustrating an example of the user interface in the third example embodiment of the present invention.

FIG. 18 is a view illustrating an example of the user interface in the third example embodiment of the present invention.

FIG. 19 is a view illustrating an example of the user interface in the third example embodiment of the present invention.

FIG. 20 is a view illustrating a configuration of an estimation device of the present invention.

FIG. 21 is a view illustrating an example of another configuration of the present invention.

### EXAMPLE EMBODIMENT

### First Example Embodiment

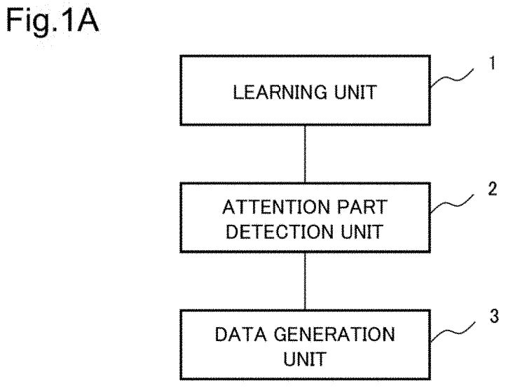

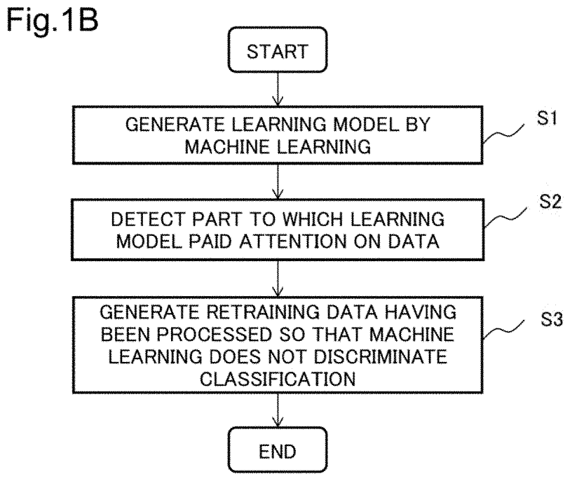

The first example embodiment of the present invention will be described in detail with reference to the drawings. FIG. 1A is a view illustrating the configuration of the learning device of the present example embodiment. FIG. 1B is a view illustrating the operation flow of the learning device of the present example embodiment. The learning device of the present example embodiment includes a learning unit 1, an attention part detection unit 2, and a data generation unit 3.

The learning unit 1 executes machine learning based on the first training data and generates a learning model for classifying a category of the first training data. The attention part detection unit 2 classifies the category of the first training data using the generated learning model. When performing the classification, the attention part detection unit 2 detects an attention part on the first training data to which the learning model pays attention. The data generation unit 3 generates second training data in which an attention part is processed based on a rate at which the attention part matches a predetermined attention determination part to which attention is to be paid. For example, in a case where a rate (matching rate) at which a part on the first training data to which attention is paid at the time of classifying a category using the learning model matches a predetermined attention determination part to which attention is to be paid (attention determination part) is lower than a predetermined value, the data generation unit 3 processes the attention part so as to reduce contribution to the classification of the attention part, and generates the second training data as the training data of the learning model. For example, the data generation unit 3 includes a matching detection unit that detects a matching rate and a data processing unit. In a case where the matching rate is lower than a predetermined value, the data processing unit processes the part to which the learning model has paid attention such that the learning model does not classify the category, and generates the second training data as the training data for the learning model by the processing.

An example of the operation of the learning device of the present example embodiment will be described. As illustrated in FIG. 1B, the learning unit 1 of the learning device of the present example embodiment executes machine learning based on the first training data and generates a learning model for classifying a category of the first training data (step S1). When the learning model is generated, the attention part detection unit 2 instructs the learning unit 1 to classify the category of the first training data by using the generated learning model. The attention part detection unit 2 detects a part to which the learning model has paid attention at the time of classification (step S2). When the part to which the learning model has paid attention is detected, the data generation unit 3 detects a rate at which the part on the first training data to which attention is paid at the time of classifying a category using the learning model matches the predetermined attention determination part.

The attention determination part, which is a part to which attention is to be paid, will be described. For example, first, in a case where the first training data is an image and a dog that is a target object appearing in the image is identified in step S2, it is assumed that the learning unit 1 classifies the image into a dog category. In this case, the attention determination part is a part in the image where the dog appears. Second, it is assumed that the first training data is language data including text data, and the learning unit 1 classifies a category implicated by the language data in step S2. In this case, the attention determination part is a part that strongly affects the classification of the category, and is, for example, a word or an expression part related to the category. Third, it is assumed that the first training data is time-series data representing a time-series signal, and the learning unit 1 classifies in step S2 a category of the time-series data, for example, whether the time-series data is abnormal or normal. In this case, the attention determination part is a part that strongly affects the classification of the category. For example, the attention determination part is a part having an abnormal waveform or a part where a sign leading to an abnormality occurs, and the part is distinguished from a normal state.

In a case where the matching rate is lower than the predetermined value, the data generation unit 3 generates the second training data in which the attention part detected in step S2 by the attention part detection unit 2 is subjected to processing (step S3). By the processing in step S3, the learning model is generated so as not to pay attention to and classify a part to which attention should not originally be paid in the learning using the second training data.

The matching rate is, for example, an index generated by comparing a part to which the learning model has paid attention with a predetermined attention determination part, and the index indicates the matching rate of the positions of both parts. Processing such that the learning model does not classify the category in a case where the matching rate is lower than a predetermined value means processing such that contribution of a part to which the attention part detection unit 2 has paid attention to classification of the category becomes small when machine learning for generating a learning model for performing classification on training data is performed. When processing is performed such that the learning model does not classify the category, processing may be performed to such an extent that the part to which the attention part detection unit 2 has paid attention does not contribute to the classification of the category. For a specific processing method, the processing method described in the second example embodiment is used. Processing to processing of preventing the learning model from classifying the category into an attention part means processing such that machine learning is not ignited at the attention part, in other words, processing that is inactivated in machine learning.

In the learning device of the present example embodiment, in a case where the matching rate is lower than a predetermined value, data obtained by processing the part to which the learning model has paid attention such that the learning model does not classify the category is used for learning as the second training data. Therefore, after the learning using the second training data, the possibility of performing the learning to classify the category by paying attention to a part to which attention should not be paid is reduced. Therefore, the learning device of the present example embodiment can generate a learning model in which learning is performed by appropriately paying attention to a place to which attention should be paid for various training data to be classified into the same category. For example, even in a case of learning a learning model using the first training data having a low classification confidence, the learning unit reconstructs the learning model by learning using the second training data, and learns so as to appropriately pay attention to the place to which attention should be paid. Therefore, the learning device of the present example embodiment can improve the classification accuracy for various data. This makes it possible to improve the estimation accuracy of category classification by the finally generated learning model.

### Second Example Embodiment

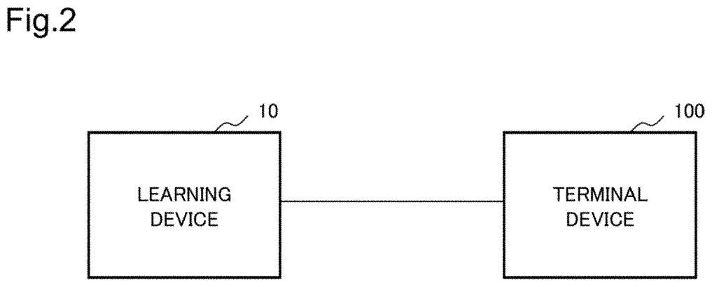

The second example embodiment of the present invention will be described in detail with reference to the drawings. FIG. 2 is a view illustrating the configuration of a learning system of the present example embodiment. The learning system of the present example embodiment includes to learning device 10 and a terminal device 100. The learning device 10 and the terminal device 100 are connected via a communication cable or a network. The learning device 10 and the terminal device 100 may be connected via a wireless line.

The learning system of the present example embodiment is a machine learning system that generates a learning model by deep learning using a neural network (NN) represented by a convolutional neural network (CNN) using analysis target data and label data as teaching data. The analysis target data is, for example, sample data to which machine learning using CNN is applicable, such as an image, language, and a time-series signal. Hereinafter, a case where a learning model for estimating a category in which an object in an image is classified is generated based on image data in which a target object whose category is classified is included in the image and label data indicating a classification category of the object will be described as an example.

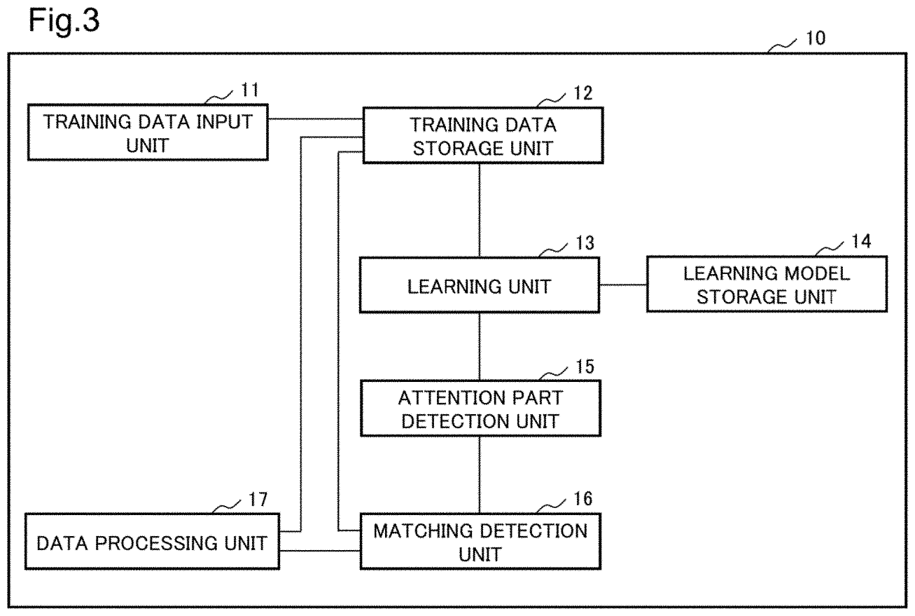

The configuration of the learning device 10 will be described. FIG. 3 is a view illustrating the configuration of the learning device 10 of the present example embodiment. The learning device 10 includes a training data input unit 11, a training data storage unit 12, a learning unit 13, a learning model storage unit 14, an attention part detection unit 15, a matching detection unit 16, and a data processing unit 17. The matching detection unit 16 and the data processing unit 17 are examples of data generation means.

The training data input unit 11 receives training data (first training data) for machine learning including image data in which a target object whose category is classified is included in the image and label data indicating classification of the target object, and information of an attention determination part. The training data input unit 11 receives the information on the attention determination part and the training data from the terminal device 100. The training data input unit 11 stores the information on the attention determination part and the training data in the training data storage unit 12 in association with each other.

The information on the attention determination part is information indicating a part where a target whose category is classified exists, and, in the case of an image, is information indicating a region on the image where a target object exists. Specifically, for example, when machine learning is performed using image data in which a dog appears and correct label data indicating the dog as teaching data, the attention determination part corresponds to a region in which the dog appears on the image.

The attention determination part is set, for example, by the user operating an input device not illustrated. The user moves a cursor so as to surround a target whose category is to be determined on an image of training data displayed on an input device or performs marking by touch input, thereby generating a trajectory indicating the position of the target. An image part surrounded by the trajectory of the marking thus generated is set as the attention determination part. The information indicating the attention determination part is image data including an image part surrounded by the marking trajectory. The marking will also be described in detail in the description of the terminal device 100.

The information on the attention determination part may be image data other than the above. Even if the training data is text data or data of a time-series signal, the information on the attention determination part is created similarly to the information on the attention determination part using the image data if the region of the part surrounded by the marking can be set by the terminal device 100.

The training data is data including teaching data used for machine learning, and is data in which image data in which a target object whose category is classified is included in an image and label data indicating classification of the object on the image data are combined.

The training data storage unit 12 stores the information on the attention determination part and the training data in association with each other. The training data storage unit 12 stores the image data (second training data) generated by the data processing unit 17 described later in association with the training data (first training data) including the image data before processing.

The learning unit 13 generates a learning model by machine learning using CNN. The learning unit 13 generates a learning model for estimating the classification of an object on image data with the training data, that is, the image data obtained by photographing the target object whose category is classified and the label data indicating the classification of the object on the image data as the teaching data that is used as an input. The learning unit 13 performs relearning using the image data generated by the data processing unit 17 and updates the learning model. The learning unit 13 stores the data of the generated learning model in the learning model storage unit 14. When performing relearning, the learning unit 13 updates the learning model stored in the learning model storage unit 14 using the result of the relearning. The learning unit 13 estimates the classification of the object on an unknown image using the learning model generated by the machine learning.

When performing classification of the category of the first training data in the learning unit 13 using the learning model, the attention part detection unit 15 detects an attention part on the first training data to which the learning model pays attention. The attention part is a part contributing to classification of the category. Specifically, when the category of the object is classified using the learning model generated by the machine learning using CNN, the region where the target object whose category is classified is recognized to exist is detected as the attention part. The attention part detection unit 15 extracts an attention part using the gradient-weighted class activation mapping (Grad-CAM) method disclosed in NPL 1, for example. Detecting a part to which the learning model pays attention using the GRAD-CAM method when estimating classification of the category using CNN is also called visualization of a characteristic site. Since the part to which the learning model has paid attention has a characteristic amount that has affected the classification, the part is also called a characteristic site.

In a case where the learning model of the machine learning is a recurrent neural network (RNN), the attention part detection unit 15 may execute detection of a part to which the learning model has paid attention and visualization of the attention part by using a visualization technique of the attention part called Attention. The technique by which the attention part detection unit 15 detects a part to which the learning model of the NN has paid attention is not limited to the technique by Grad-CAM or Attention. The technique by Attention is disclosed in F. Wang, et al., “Residual Attention Network for Image Classification”, arXiv:1704.06904v1 [cs.CV] 23 Apr. 2017, and detailed description is omitted.

The matching detection unit 16 uses the information on the attention determination part associated with the training data and the data of the part detected using the Grad-CAM method. The matching detection unit 16 determines the rate at which a part to which the learning model pays attention when estimating classification of the category of the object matches the attention determination part. For example, the matching detection unit 16 compares the data of the attention determination part associated with the training data with the information on the attention part detected using the Grad-CAM method, and calculates the matching rate.

For example, the matching detection unit 16 detects the number of pixels (first number of pixels) of a part where the attention determination part and the part to which attention is paid overlap each other. The matching detection unit 16 detects the number of pixels (second number of pixels) of the attention part detected by the attention part detection unit 15. The matching detection unit 16 calculates, as a matching rate, a ratio of the detected first number of pixels to the second number of pixels. When the matching rate is less than a criterion value set in advance, the matching detection unit 16 determines that the part to which the learning model has paid attention does not match the attention determination part.

The data processing unit 17 performs processing of preventing the learning model from classifying the category of the part to which the learning model has paid attention regarding an image of the training data for which the matching rate is determined to be less than the criterion value. Therefore, the processed second training data does not have a characteristic that machine learning can recognize existence of a target whose category is classified. Processing such that the learning model does not classify the category is also called inactivating with respect to machine learning. In a case where the learning unit 13 performs machine learning of relearning using the second training data and updating the learning model, it is possible to avoid that the machine learning is not activated by an erroneous attention part, that is, the erroneous attention part contributes to classification to the category.

The data processing unit 17 prevents the learning model from classifying the category, for example, by lowering the contrast ratio of a part other than the image part corresponding to the attention determination part associated with the training data to equal to or less than a preset criterion. The processing of preventing the learning model from classifying the category may be performed only on the attention part where the matching rate with the attention determination part has become less than the criterion. The processing of preventing the learning model from classifying the category may be performed by changing, into a preset range, a difference in one or both of luminance and chromaticity between pixels in the region to be processed.

Processing of preventing the learning model from classifying the category may be performed by adding noise with a random pattern or adding a large number of figures of dot patterns or other patterns to the attention part where the matching rate with the attention determination part has become less than the criterion. Processing of preventing the learning model from classifying the category may be performed by filling, with a preset color, the attention part where the matching rate with the attention determination part has become less than the criterion.

The data processing unit 17 changes the processing strength according to the matching rate. The data processing unit 17 changes, according to the matching rate, the contrast ratio of a part other than the image part corresponding to the attention determination part. The data processing unit 17 performs processing so as to decrease the contrast ratio as the matching rate decreases. The relationship between the matching rate and the contrast ratio is set in advance. When the luminance and chromaticity between the pixels in the region to be processed are changed, similarly, the difference in luminance and chromaticity between the pixels is reduced as the matching rate decreases.

The data processing unit 17 may change the size of the part to be processed according to the matching rate when processing is performed on the attention part by the learning model in which the matching rate with the attention determination part has become less than the criterion. For example, the data processing unit 17 performs processing such that the part to be processed becomes larger as the matching rate decreases. The data processing unit 17 may change the density of the random pattern or noise according to the matching rate when performing processing of preventing the learning model from classifying the category by adding noise or a dot pattern by the random pattern to the attention part where the matching rate with the attention determination part has become less than the criterion. For example, the data processing unit 17 performs processing such that the density of the random pattern and noise increases as the matching rate decreases.

The strength of processing of preventing the learning model from classifying the category by the data processing unit 17 may be set in stages according to the stage of the matching rate by dividing the matching rate into a plurality of stages. The processing in which the data processing unit 17 prevents the learning model from classifying the category may be performed by combining the above-described processing methods according to the matching rate. The processing in which the data processing unit 17 prevents the learning model from classifying the category may be performed with a predetermined certain strength set in advance when the matching rate is less than the criterion.

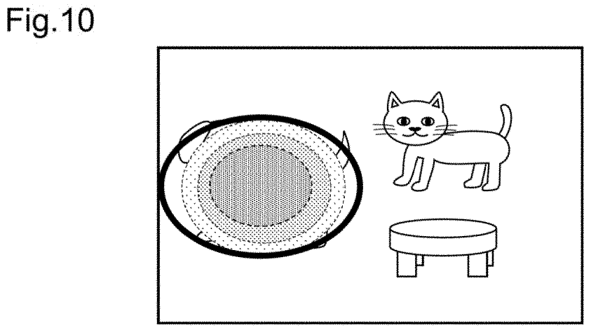

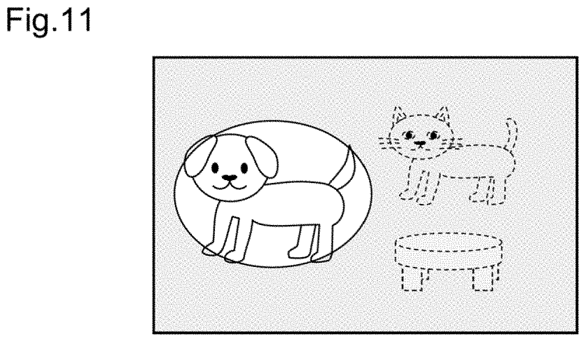

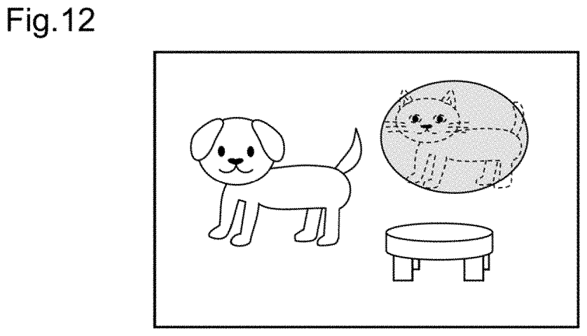

FIG. 10 is a view schematically illustrating an example of a comparison image in which an attention part detected by the Grad-CAM method and an attention determination part associated with an image of training data are illustrated on the same image. FIGS. 11 and 12 are views schematically illustrating examples of a case where processing of preventing the learning model from classifying the category with a part other than the image part corresponding to the attention determination part is performed on the image data.

FIG. 11 illustrates an example of a case where the contrast ratio of the part other than the image part corresponding to the attention determination part is decreased to a predetermined value. FIG. 12 illustrates an example of a case where the contrast ratio is decreased to a predetermined value only for the attention part where the matching rate with the attention determination part has become less than the criterion. By performing the processing as in FIG. 11 or FIG. 12, the attention part where the matching rate with the attention determination part has become less than the criterion can be made a part that does not contribute to the classification of the category, and thus the possibility of correctly paying attention to the part of the dog when learning is performed using the processed image increases.

Each processing in the training data input unit 11, the learning unit 13, the attention part detection unit 15, the matching detection unit 16, and the data processing unit 17 is performed by executing a computer program on a central processing unit (CPU) or a CPU and a graphics processing unit (GPU). The computer program for performing each processing is recorded in, for example, a hard disk drive. The CPU or the CPU and the GPU execute each processing by reading a computer program performing the processing on a memory.

The training data storage unit 12 and the learning model storage unit 14 are configured by a storage device such as a nonvolatile semiconductor storage device or a hard disk drive, or a combination of these storage devices. One or both of the training data storage unit 12 and the learning model storage unit 14 may be provided outside the learning device 10 and connected via a network. The learning device 10 may be configured by combining a plurality of information processing devices.

[Configuration of Terminal Device 100]

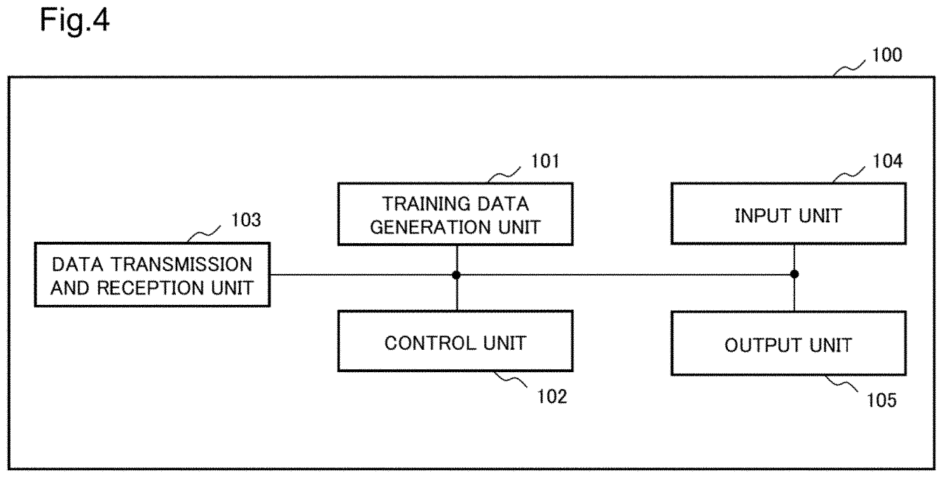

The configuration of the terminal device 100 illustrated in FIG. 2 will be described. FIG. 4 is a view illustrating the configuration of the terminal device 100 of the present example embodiment. The terminal device 100 is a worker's operation terminal that generates training data when performing machine learning to generate a learning model. The terminal device 100 of the present example embodiment includes a training data generation unit 101, a control unit 102, a data transmission and reception unit 103, an input unit 104, and an output unit 105.

The training data generation unit 101 generates data of an attention determination part. The generation method of the data of the attention determination part will be described later. The data of the attention determination part is generated, for example, as image data in which the attention determination part is surrounded by a line in an image having the same size as the image data used for the learning model, that is, the same number of pixels. The data of the attention determination part is only required to be one in a format that can specify the attention determination part on the image, and may be, for example, image data in which a part other than the attention determination part is filled with black or another color. The training data generation unit 101 outputs the data of the attention determination part as data associated with the training data.

The control unit 102 controls the overall operation of the terminal device 100 and transmission and reception of data necessary for machine learning in the learning device 10. The control unit 102 controls the output of the image data received from the learning device 10 and the data of the matching rate to a display device, and controls the operation according to the input result of the worker.

The data transmission and reception unit 103 transmits the training data associated with the information on the attention determination part to the learning device 10. The data transmission and reception unit 103 receives, from the learning device 10, data that needs to be confirmed or selected by the worker when machine learning is performed, such as image data subjected to the processing of preventing the learning model from classifying the category, a calculation result of the matching rate, and a generation result of the learning model.

The input unit 104 receives information indicating an attention determination part in an image used for training data. The input unit 104 receives an input from an input device such as a mouse, a graphics tablet, or a keyboard. The input device that sends input data to the input unit 104 may be configured by combination of a plurality of types of input devices.

When performing setting of the attention part, the output unit 105 outputs, to a display device, display data of an image in which setting is performed. The output unit 105 outputs the display data of the information transmitted from the learning device 10 to the display device based on the instruction of the control unit 102.

Each processing in the training data generation unit 101, the control unit 102, the data transmission and reception unit 103, the input unit 104, and the output unit 105 of the terminal device 100 is performed by executing a computer program on the CPU. The computer program for performing each processing is recorded in, for example, a hard disk drive. The CPU executes the computer program for performing each processing by reading the computer program on the memory.

[Operation of Learning System]

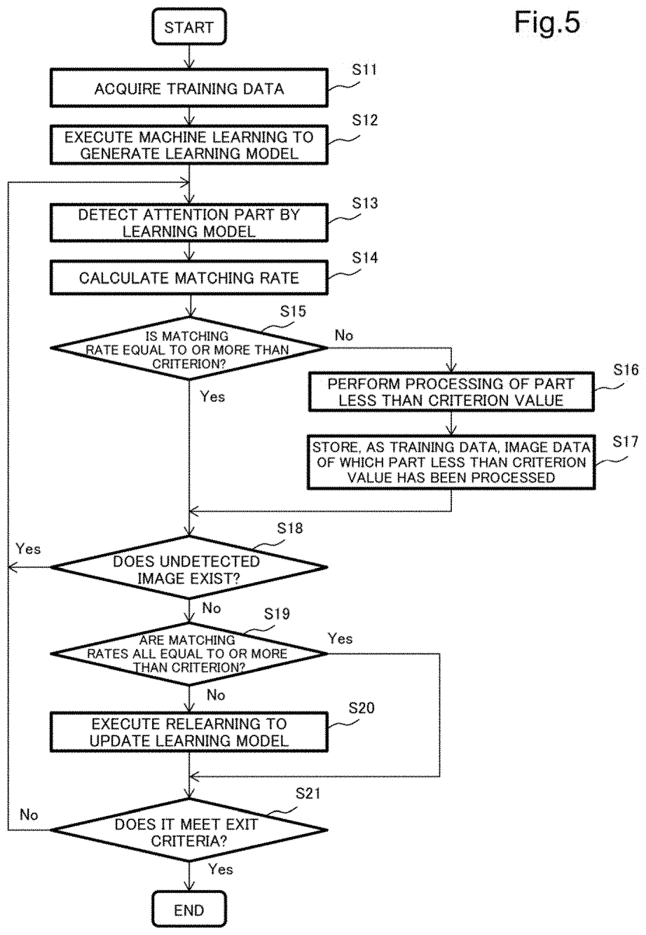

The operation of the learning system of the present example embodiment will be described. FIG. 5 is a view illustrating the operation flow of the learning device 10 in the learning system of the present example embodiment.

First, the terminal device 100 generates data in which the information on the attention determination part is added to the training data. The information on the attention determination part is generated by adding a trajectory by marking surrounding the part of the object to which attention is paid to the image data in which the target object whose category is classified is photographed. It is generated before processing used for machine learning and associated with training data. The image data is input by the worker to the terminal device 100 before the start of work. The image data may be input to the terminal device 100 via a network. The image data may be stored in advance in the learning device 10 or the terminal device 100.

The control unit 102 of the terminal device 100 requests the output unit 105 to output the image data to which the information on the attention determination part is added. Upon receiving the request to output of the image data, the output unit 105 generates and outputs, to the display device, image data for requesting designation of the classification of the image and designation of the attention determination part.

The generation of the information on the attention determination part is performed by marking a region on the image where the target object whose category is classified appears. The information on the attention determination part added by marking is associated with training data with the marked part as image data different from the original image data. The information on the attention part may be associated with the training data as data of only numerical information indicating the position and range of the marked part as coordinate data.

The marking is performed, for example, by surrounding, with a line, an outline of a region where the target object whose category is classified appears. The marking may be performed by surrounding, with a quadrangular or another polygonal line, a region where the target object whose category is classified appears. Not only being surrounded by a line but also given a plurality of points, the marking may be performed so that an internal region where the points are connected by a straight line is set as the attention determination part. The marking may be performed by adding a circle mark or another shape mark to a region where the target object whose category is classified appears. In such a configuration, a certain range around the marked point may be set as the attention determination part.

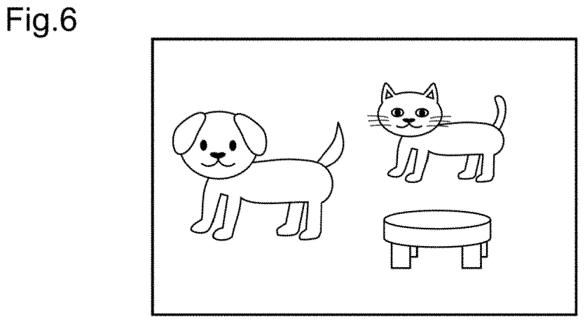

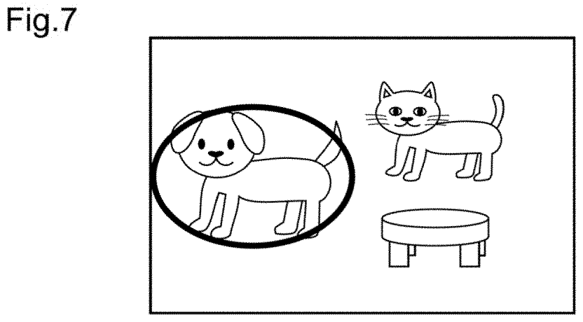

FIG. 6 is a view schematically illustrating an example of an image in which a target object whose category is classified appears. FIG. 6 illustrates a case where there are a dog that is to be a target whose category is classified, a cat, and furniture on an image. For convenience of drawing creation, the background is omitted in FIG. 6, but the background shall exist in the actual image. FIG. 7 is a view schematically illustrating an example of an image in which marking of an attention determination part is performed. In FIG. 7, marking is performed by surrounding, with a line as an attention determination part, a dog that is a target whose category is classified. The region corresponding to the attention determination part surrounded by the marking is generally a region around the face of the dog rather than the entire dog.

Upon completing the generation of the training data associated with the information on the attention determination part, the control unit 102 requests the data transmission and reception unit 103 to transmit the training data associated with the attention determination part to the learning device 10. Upon receiving the request to transmit the training data associated with the information on the attention determination part to the learning device 10, the data transmission and reception unit 103 sends the training data associated with the information on the attention determination part to the learning device 10.

The training data sent from the terminal device 100 to the learning device 10 is input from the training data input unit 11 to the learning device 10. Since inputting the training data associated with the information on the attention determination part, the training data input unit 11 stores the training data associated with the information on the attention determination part in the training data storage unit 12 (step S11).

Upon storing the training data, the learning unit 13 performs machine learning using CNN based on the training data (here, first training data) to generate a learning model (step S12). The machine learning using the training data is iteratively performed a preset number of times using a plurality of pieces of first training data. The learning unit 13 stores the data of the generated learning model in the learning model storage unit 14.

Upon generating the learning model, the process proceeds to the operation of the attention part detection unit 15. That is, the attention part detection unit 15 instructs the learning unit 13 to perform processing of estimating the classification of the object using the learning model, for example, with the image data used for machine learning as an input. Upon executing the processing of estimating the classification of the object, the attention part detection unit 15 detects a part that has contributed to the classification to a category when the learning model classifies the object of the image data, that is, a part to which the learning model has paid attention (hereinafter, also called attention part) (step S13).

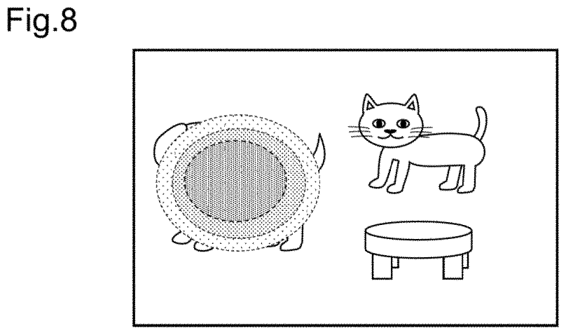

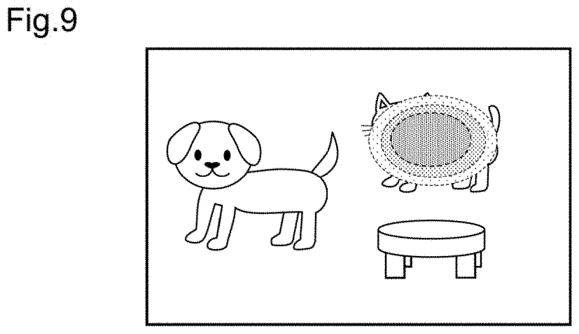

The attention part detection unit 15 detects, for each image, information on the attention part when detecting a target object whose category is classified from the image using the Grad-CAM method. FIGS. 8 and 9 are views schematically illustrating an example in which the information indicating an attention part detected using the Grad-CAM method is added to an image as a heat map. In the example of FIG. 8, the learning model using the CNN pays attention to the dog. In the example of FIG. 9, the learning model using the CNN pays attention to the cat. At this time, assuming that the correct category of the label data is the dog, in the example of FIG. 8, the learning model pays attention to the correct part on the image. On the other hand, in the example of FIG. 9, the learning model pays attention to a part different from the part requiring attention, that is, a part where the dog exists.

Upon detecting the information on the attention part, the attention part detection unit 15 sends the information of the detected attention part to the matching detection unit 16. Upon receiving the information on the attention part, the information on the attention determination part associated with the corresponding training data is read from the matching detection unit 16 and the training data storage unit 12. Upon reading the information on the attention part, the matching detection unit 16 compares the attention part detected by the Grad-CAM method with the attention determination part associated with the training data.

The matching detection unit 16 calculates a rate at which the position of the attention part detected by the attention part detection unit 15 matches the position of the attention determination part associated with the training data (step S14). Specifically, the matching detection unit 16 counts the number of pixels in which the attention part detected by the attention part detection unit 15 and the attention determination part associated with the training data overlap each other. Next, the matching detection unit 16 calculates, as a matching rate, a ratio of the number of overlapping pixels to the number of pixels of the attention determination part associated with the training data. Upon calculating the matching rate, the matching detection unit 16 compares the matching rate with a preset criterion value.

When the matching rate is less than the criterion (No in step S15), the matching detection unit 16 determines that the image data whose matching rate is less than the criterion needs processing of preventing the learning model from classifying the category. Upon determining the processing of preventing the learning model from classifying the category is needed, the matching detection unit 16 sends a request for processing of inactivation of the image data to the data processing unit 17.

Upon receiving the request for processing of inactivation of the image data, the data processing unit 17 performs processing of preventing the learning model from classifying the category of a non-matched attention part for the image data whose matching rate is less than the criterion (step S16). On the basis of the information on the attention determination part associated with the training data of the training data storage unit 12, the data processing unit 17 performs, for the image data, processing of preventing the learning model from classifying the category of the non-matched attention part, that is, a part other than the image part corresponding to the attention determination part applied with marking in advance.

Upon performing the processing of the image data, the data processing unit 17 stores, in the training data storage unit 12, the image data subjected to processing of preventing the learning model from classifying the category for the part to which attention should not be paid (step S17). When there is an image whose matching rate has not been detected when the processed data is stored as the training data (Yes in step S18), the image data whose matching rate has not been detected is output from the training data storage unit 12 to the learning unit 13, and the operation from step S13 is repeated. When there is no image whose matching rate has not been detected when the processed data is stored as the training data (No in step S18), it is confirmed whether the matching rate is equal to or more than the criterion in all the images. In this case, there is an image whose matching rate is less than the criterion and subjected to processing of preventing the learning model from classifying the category, and the matching rate is not equal to or more than the criterion in all the images, and the determination is No in step S19. When No in step S19, the learning unit 13 performs relearning of the learning model by using the training data stored in the training data storage unit 12.

The relearning is performed using, as teaching data, the image data subjected to the processing of preventing the learning model from classifying the category, and the image data not subjected to the processing of preventing the learning model from classifying the category because the matching rate exceeds the criterion. When relearning is performed, the number of pieces of image data having not been subjected to the processing may be set to the number of pieces of image data that have been subjected to the processing. When relearning is performed, new training data may be used as teaching data.

Upon completing the relearning, the learning unit 13 updates the data of the learning model of the learning model storage unit 14 with the learning model generated as a result of the relearning (step S20).

Upon updating the data of the learning model, the learning unit 13 verifies the estimation accuracy of the generated learning model. In the verification of the accuracy of the learning model, for example, the learning unit 13 reads image data of a plurality of verification images and estimates the classification of the object on the verification image using the learning model. The learning unit 13 performs the verification of the accuracy of the learning model by comparing the result of the classification of (the category of) the estimated object with the label data indicating the correct answer associated with the image data. In a case where the verification of the accuracy is performed by such a method, the learning unit 13 determines that the accuracy is sufficient and meets an exit criterion in a case where the rate (correct answer rate) of the image in which the estimation result and the label data match is equal to or more than a preset value. When the exit criterion is met (Yes in step S21), the generation of the learning model is completed. The learning model having been generated is used to estimate the classification of the category of the image data. When the exit criterion is not met (No in step S21), the operation from step S13 is repeated, and the processing of preventing the learning model from classifying the category for the image for which the matching rate does not meet the criterion is performed. The reprocessing of the image in which the matching rate is less than the criterion is performed, for example, by lowering the contrast ratio to be lower than that at the time of the previous processing.

When the matching rate calculated in step S15 is equal to or more than the criterion (Yes in step S15), the matching detection unit 16 determines that the processing of preventing the learning model from classifying the category is unnecessary for the corresponding image data. When determining that the inactivation processing is unnecessary, the matching detection unit 16 may add information indicating that the inactivation processing has not been performed to the training data. Next, in step S18, when there is an image whose matching rate has not been detected (Yes in step S18), image data whose matching rate has not been detected is output from the training data storage unit 12 to the learning unit 13, and the operation from step S13 is repeated. When there is no image whose matching rate has not been detected when the processed data is stored as the training data (No in step S18), it is confirmed whether the matching rate is equal to or more than the criterion in all the images. When the matching rate is not equal to or more than the criterion in all the images, that is, when there is an image subjected to processing of preventing the learning model from classifying the category (No in step S19), the learning unit 13 performs relearning using the training data of the training data storage unit 12. The relearning is performed using both the image data subjected to the processing of preventing the learning model from classifying the category and the image data having the matching rate equal to or more than the criterion and not subjected to the processing of preventing the learning model from classifying the category. Upon completing the relearning, the learning unit 13 updates the data of the learning model of the learning model storage unit 14 with the learning model generated as a result of the relearning (step S20).

Upon updating the data of the learning model, the learning unit 13 verifies the accuracy of the generated learning model. The accuracy of the learning model is also verified when Yes in step S19, that is, when the matching rate is equal to or more than the criterion in all the images and there is no image subjected to processing of preventing the learning model from classifying the category.

When the exit criterion is met by the verification of the accuracy of the learning model (Yes in step S21), the generation of the learning model is completed. The learning model having been generated is used to estimate the classification of the image data. When the exit criterion is not met (No in step S21), the operation from step S13 is repeated, and the processing of preventing the learning model from classifying the category for the image for which the matching rate does not meet the criterion is performed. The processing of preventing the learning model from classifying the category performed after relearning is performed, for example, by further lowering the contrast ratio of a part other than the attention determination part associated with the training data or expanding a region to be inactivated.

In the above description, the processing from the detection of the attention part by the learning model to the determination of the matching rate and the processing of the image is performed for each piece of image data. Instead of such the processing method, an image having a matching rate less than the criterion may be processed after an attention part is detected by the learning model for a plurality of pieces of image data or all pieces of image data.

Alternatively, instead of step S18, it may be determined whether there is an undetected image for all the training data of the predetermined number of images. Steps S19 and S20 may be omitted.

In the above description, the learning device 10 and the terminal device 100 are devices independent of each other, but the learning device 10 may have some or all of the functions of the terminal device 100. In the above description, the configuration of estimating the classification of an object on an image has been described, but the learning device 10 can also be used for language analysis and time-series signal analysis. In the case of application to language analysis, which part of language or signal attention is being paid is detected by applying the Grad-CAM method to a learning model generated by machine learning using the CNN or RNN.

In signal analysis of a time-series signal, machine learning by CNN is performed with a time-series signal data and a phenomenon indicated by the signal data as teaching data, and information of a part of the signal data to which the learning model pays attention is detected by the Grad-CAM method. For example, it is possible to perform machine learning using CNN with a phenomenon relevant to waveform data of vibration of a building, a machine, or the like, a natural phenomenon such as an earthquake, or a phenomenon relevant to waveform data of an observation result of a living body such as an electrocardiogram as teaching data, and detect, using the Grad-CAM method, information of a part to which the learning model pays attention. Thus, when the detected attention part is different from the part relevant to the estimation target phenomenon, by flattening the waveform of the signal of the part to which the learning model has paid attention or adding noise, it is possible to generate training data subjected to processing of preventing the learning model from classifying the category. Also in language analysis, when the accuracy of recognition of a word is low, a part to which the learning model pays attention is detected using the Grad-CAM method, and processing of preventing the learning model from classifying the category is performed to a part that is considered to affect erroneous recognition, whereby training data that improves the accuracy of recognition can be generated.

The learning device 10 of the present example embodiment detects a part to which a learning model generated by machine learning using CNN or RNN pays attention when classifying the category of data. In a case where the rate at which an attention part at the time of classifying the category using a learning model matches a preset attention determination part is lower than a predetermined value, the learning device 10 generates training data to be used at the time of relearning by performing processing of preventing the learning model from classifying the category on the part to which the learning model pays attention. When the learning model pays attention to a part having a low rate of matching the preset attention determination part, relearning is performed using, as training data, data subjected to processing of preventing the learning model from classifying the category to the part to which the learning model pays attention, thereby performing that pays more attention to the target for classification of the category. Therefore, the learning device 10 of the present example embodiment can generate a learning model that can accurately estimate the classification of the category even when data where identification between a part that becomes the target of classification of the category and another part is difficult is input. As a result, it is possible to improve the accuracy of category classification estimation by performing estimation using a learning model generated using the learning device 10 of the present example embodiment.

### Third Example Embodiment

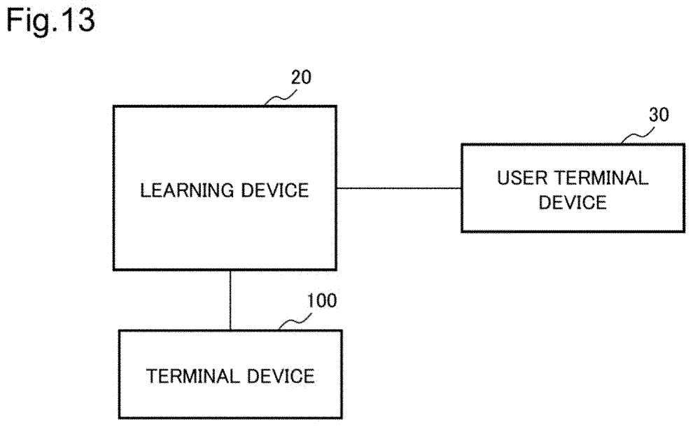

A learning system according to the third example embodiment of the present invention will be described in detail with reference to the drawings. FIG. 13 is a view illustrating the configuration of a learning system of the present example embodiment. In the learning system of the present example embodiment, when performing, on an image, processing of preventing a learning model from paying attention to a part to which attention should not originally be paid and classifying a category, a candidate of the image after processing is indicated to a user via a user terminal device used by the user. The user refers to a person who receives provision of a learning model and uses the learning model for data analysis.

The learning system of the present example embodiment includes a learning device 20, a user terminal device 30, and the terminal device 100. The configuration and function of the terminal device 100 are similar to those of the second example embodiment. The learning device 20 and the terminal device 100 are connected via a communication cable or a network. The learning device 20 and the user terminal device 30 are also connected via a communication cable or a network. The learning device 20 and the user terminal device 30 may each be connected to the terminal device 100 via wireless lines.

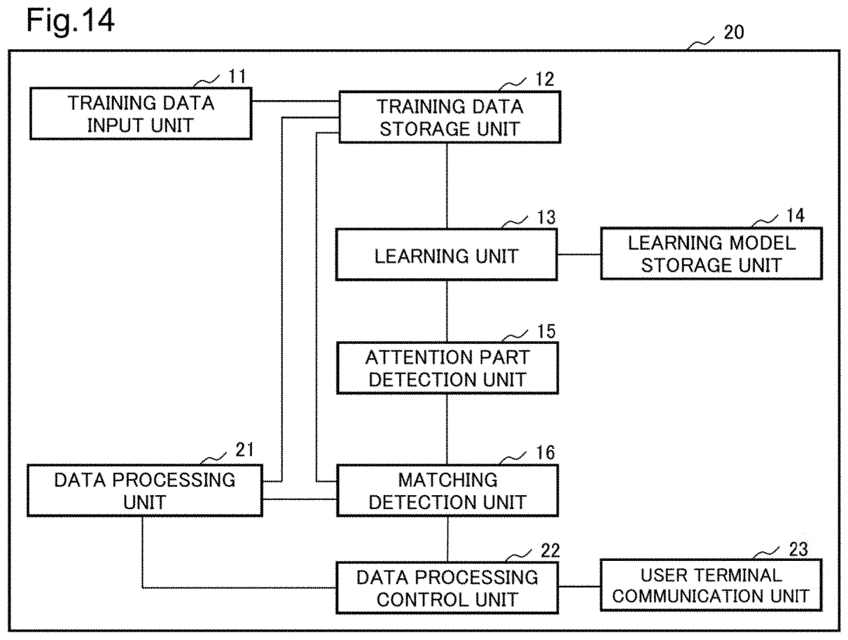

The configuration of the learning device 20 will be described. FIG. 14 is a view illustrating the configuration of the learning device 20 of the present example embodiment. The learning device 20 of the present example embodiment includes the training data input unit 11, the training data storage unit 12, the learning unit 13, the learning model storage unit 14, the attention part detection unit 15, the matching detection unit 16, a data processing unit 21, a data processing control unit 22, and a user terminal communication unit 23.

The configurations and functions of the training data input unit 11, the training data storage unit 12, the learning unit 13, the learning model storage unit 14, the attention part detection unit 15, and the matching detection unit 16 of the learning device 20 of the present example embodiment are similar to those of the portions having the same names of the second example embodiment.

Similarly to the data processing unit 17 of the second example embodiment, the data processing unit 21 performs processing of preventing the learning model from classifying the category of the part to which the learning model pays attention. The data processing unit 21 generates a plurality of image candidates when performing processing of preventing the learning model from classifying the category.

The data processing unit 21 generates a plurality of image candidates having different contrast ratios when performing processing of lowering the contrast ratio on a part other than the attention determination part associated with the learning model, for example. The data processing unit 21 calculates an average contrast ratio of a region to be processed, for example, and generates a plurality of image candidates in which the contrast ratio of the region to be processed is lower than the calculated average value and the contrast ratios are different from each other. The data processing unit 21 may generate a plurality of image candidates by changing the range covering the part to which the learning model pays attention.

The data processing control unit 22 sends the image candidate generated by the data processing unit 21 to the user terminal device 30 via the user terminal communication unit 23. The data processing control unit 22 instructs the data processing unit 21 about the image data to be used as the training data based on the selection result of the image candidates received from the user terminal device 30.

The user terminal communication unit 23 transmits and receives data to and from the user terminal device 30 via the network. The user terminal communication unit 23 transmits, to the user terminal device 30, the data of the image candidate input from the data processing control unit 22. The user terminal communication unit 23 sends, to the data processing control unit 22, the selection result of the image candidate received from the user terminal device 30.

Each processing in the training data input unit 11, the learning unit 13, the attention part detection unit 15, the matching detection unit 16, the data processing unit 21, the data processing control unit 22, and the user terminal communication unit 23 is performed by executing a computer program on the CPU or the CPU and the GPU. The computer program for performing each processing is recorded in, for example, a hard disk drive. The CPU or the CPU and the GPU execute each processing by reading a computer program performing the processing on a memory.

The training data storage unit 12 and the learning model storage unit 14 of the learning device 20 are configured by a storage device such as a nonvolatile semiconductor storage device or a hard disk drive, or a combination of these storage devices. One or both of the training data storage unit 12 and the learning model storage unit 14 may be provided outside the learning device 20 and connected via a network. The learning device 20 may be configured by combining a plurality of information processing devices.

The user terminal device 30 displays, on the display device, and presents, to the user, data of the image candidate when performing processing of preventing the learning model from classifying the category. The user terminal device 30 transmits the selection result of the user to the learning device 20. As the user terminal device 30, an information processing device having a communication function, such as a personal computer or a tablet terminal device, is used.

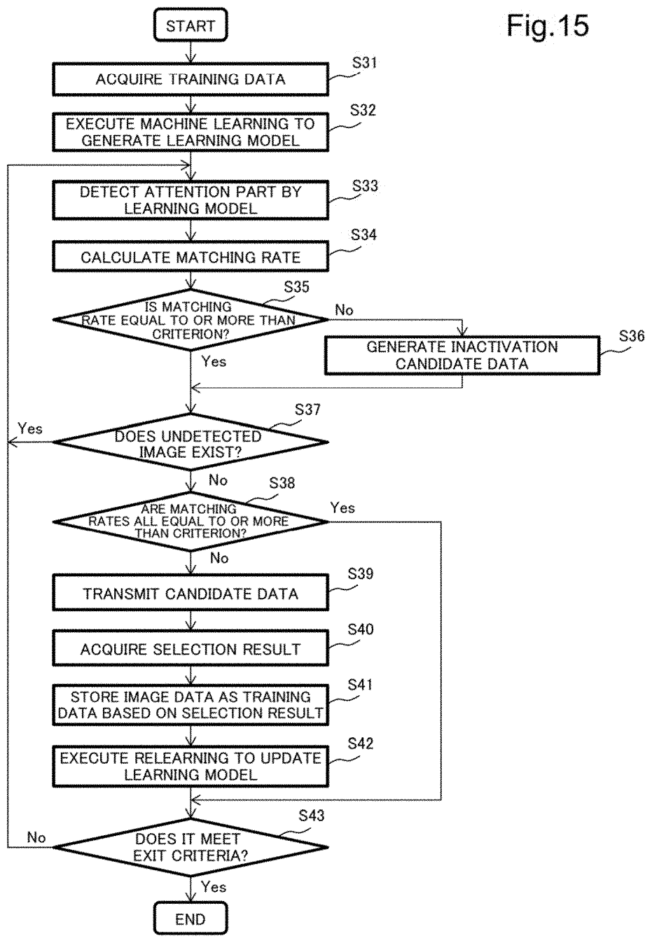

The operation of the learning system of the present example embodiment will be described. FIG. 15 is a view illustrating the operation flow of the learning device 20.

In the present example embodiment, the operation of generating training data to which information on the attention part is added is similar to that of the second example embodiment. In the present example embodiment, the operation from steps S31 to S34 in which machine learning using the CNN with the generated training data as the teaching data and is iteratively performed a preset number of times to generate a learning model, detect the attention part, and calculate the matching rate is the same as the operation from steps S11 to S14 in the second example embodiment. Therefore, in the following, the operation after calculating the matching rate in step S34 will be described.

Upon calculating the matching rate in step S34, the matching detection unit 16 compares the calculated matching rate with a preset criterion value.

When the calculated matching rate is less than the criterion (No in step S35), the matching detection unit 16 determines that it is necessary to perform processing of preventing the learning model from classifying the category on the image part other than the attention determination part associated with the training data for the corresponding image data. When determining that it is necessary to perform processing of preventing the learning model from classifying the category, the matching detection unit 16 sends, to the data processing unit 21, a request for processing of preventing the learning model from classifying the category.

Upon receiving the request for processing of preventing the learning model from classifying the category, the data processing unit 21 performs processing of preventing the learning model from classifying the category on the part other than the attention determination part associated with the training data (step S36). The processing for preventing the learning model from classifying the category is performed similarly to the second example embodiment.

The data processing unit 21 generates a plurality of image candidates when performing processing of preventing the learning model from classifying the category. The data processing unit 21 generates a plurality of image candidates having different contrast ratios when performing processing of lowering the contrast ratio on a part other than the attention part added to the learning model, for example. The data processing unit 21 calculates an average contrast ratio of a region to be processed, for example, and generates a plurality of image candidates in which the contrast ratio of the region to be processed is lower than the calculated average value and the contrast ratios are different from each other. The data processing unit 21 may generate a plurality of image candidates by changing the range covering the part to which the learning model pays attention.

Upon performing processing of preventing the learning model from classifying the category, the data processing unit 21 temporarily stores the inactivated image data. When there is an image for which the determination of the matching rate has not been completed when the data processing unit 21 stores the image data (Yes in step S37), the process returns to step S33, and the part to which the learning model pays attention is detected for the image for which the determination of the matching rate has not been completed.

When the determination of the matching rate has been completed for all the images (No in step S37) when the data processing unit 21 stores the image data, it is confirmed whether the matching rate is equal to or more than the criterion for all the images. When the matching rate is not equal to or more than the criterion in all the images, that is, when there is an image subjected to processing of preventing the learning model from classifying the category (No in step S38), the data processing unit 21 sends the data of the image candidate of the generated candidate to the data processing control unit 22. Upon receiving the data of the image candidate, the data processing control unit 22 sends the data of the image candidate to the user terminal communication unit 23. Upon receiving the data of the image candidate and the transmission request, the user terminal communication unit 23 transmits the received image candidate data to the user terminal device 30 via the network (step S39).

The user terminal device 30 receives the data from the learning device 20 via the network and acquires the data of the candidate image. Upon acquiring the image candidate data, the user terminal device 30 generates display data when the user selects any image from the image candidate, and displays the display data on the display device.

The user selects appropriate processing content from the image candidate data with reference to the display, and inputs a selection result. The selection of the processing content may be performed for each image or may be performed for each classification of the object.

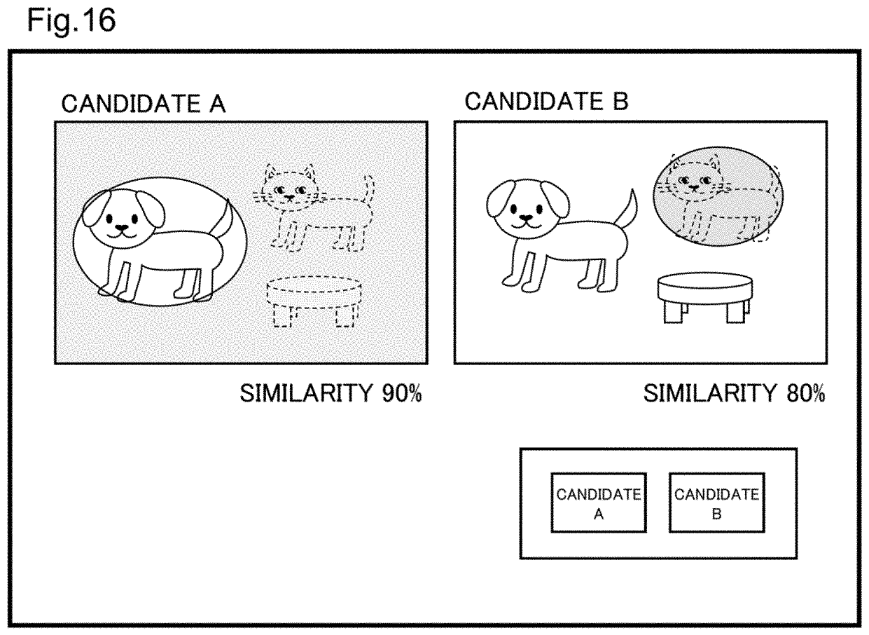

FIG. 16 is a view schematically illustrating an example of display data sent from the candidate data output unit 33 to the display device. In the example of FIG. 16, the processed images in a case where two types of processing are performed on one image are illustrating as candidates A and B. A selection button when the user selects a candidate image is displayed. The user inputs a selection result by selecting the candidate A or the candidate B using a mouse, for example.

When the user inputs the selection result, the user terminal device 30 transmits the selection result to the learning device 20 via the network.

The user terminal communication unit 23 of the learning device 20 receives data from the user terminal device 30 via the network and acquires the selection result (step S40). Upon acquiring the selection result, the user terminal communication unit 23 sends the acquired selection result to the data processing control unit 22. Upon receiving the selection result, the data processing control unit 22 sends, to the data processing unit 21, information selected with the image indicated by the selection result as image data to be used as training data.

Upon receiving the information of the image data to be used as the training data, the data processing unit 21 stores the image data corresponding to the received information in the training data storage unit 12 as the training data (step S41). When the processed image data is stored as the training data, the learning unit 13 executes machine learning using CNN again using the stored training data and preforms relearning of the learning model (step S42). The relearning is performed using both the image data subjected to the processing of preventing the learning model from classifying the category and the image data having the matching rate equal to or more than the criterion and not subjected to the processing of preventing the learning model from classifying the category.

Upon completing the relearning, the learning unit 13 verifies the estimation accuracy by the learning model. The accuracy of the learning model is verified also when Yes in step S38, that is, the matching rate is equal to or more than the criterion in all the images and there is no image subjected to processing of preventing the learning model from classifying the category.

The verification of the estimation accuracy is performed similarly to the second example embodiment. When the estimation accuracy meets the criterion when the estimation accuracy is verified by the learning model (Yes in step S43), the generation of the learning model is completed. When the estimation accuracy does not meet the criterion (No in step S43), the process returns to step S33, and processing of preventing the learning model from classifying the category is performed on the image whose matching rate does not meet the criterion.

In the above example, an example in which the user terminal device 30 displays, on the display device, the state of the image after processing for each processing content at the time of selecting the processing content has been described. The user terminal device 30 may display a part to which the learning model pays attention on the display device in a superimposed manner on the image.

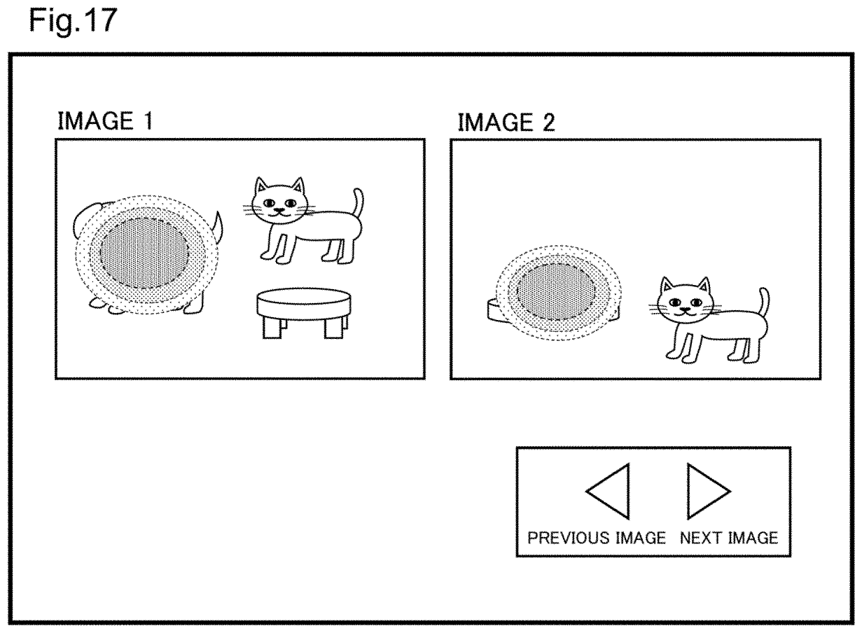

FIG. 17 is a view schematically illustrating an example of display data in which a part to which the learning model pays attention is superimposed on an image. In FIG. 17, a part to which the learning model pays attention to each of an image 1 and an image 2 is illustrated as a heat map. In the display data of FIG. 17, operation buttons for displaying other images are displayed.

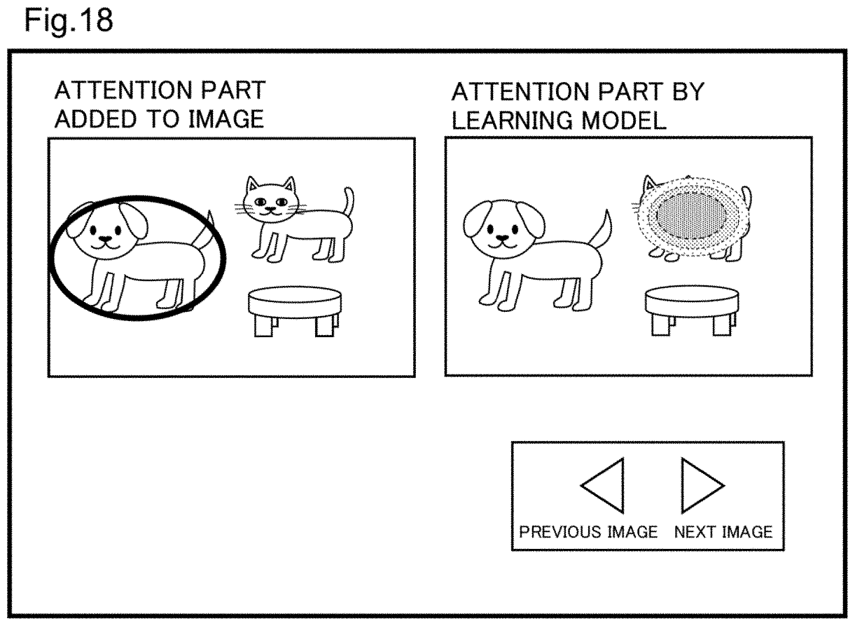

FIG. 18 is a view schematically illustrating an example of display data in which an attention part added to an image used as training data and image data in which the attention part to which the learning model pays attention is illustrated on the image are displayed side by side. FIG. 18 illustrates display data in which an image in which marking of the attention part added to the image is indicated and an image indicated as a heat map of the attention part to which the learning model pays attention are displayed side by side. In the display data of FIG. 18, operation buttons for displaying other images are displayed.

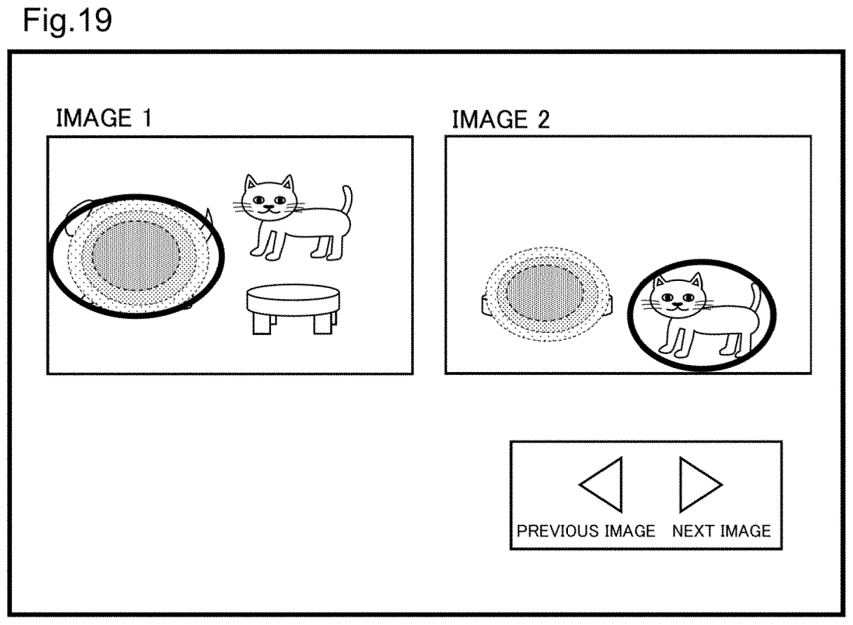

FIG. 19 is a view schematically illustrating an example of display data in which an attention part added to an image used as training data and image data in which the attention part to which the learning model pays attention is illustrated on the image are displayed in an overlapping manner. In FIG. 19, for two images of the image 1 and the image 2, marking of the attention part added to the image and a heat map of the part to which the learning model has paid attention are illustrated on the same image in an overlapping manner. In the display data of FIG. 19, operation buttons for displaying other images are displayed.

In the above description, the processing from the detection of the attention part by the learning model to the determination of the matching rate and the processing of the image is performed for each piece of image data. Instead of such the processing method, an image having a matching rate less than the criterion may be processed after an attention part is detected by the learning model for a plurality of pieces of image data or all pieces of image data.

In the above description, the learning device 20, the user terminal device 30, and the terminal device 100 are devices independent from one another, but may have some or all of the functions of other devices. For example, the learning device 20 may have some or all of the functions of the terminal device 100. The user terminal device 30 and the terminal device 100 may be configured as an integrated device, or may have some of the functions of other devices in an overlapping manner. In the above description, the configuration of estimating the classification of an object on an image has been described, but the learning device 20 can also be used for language analysis and time-series signal analysis similarly to the second example embodiment.

The learning system of the present example embodiment transmits, to the user terminal device 30, image data indicating a state after processing when performing processing of preventing the learning device 20 from classifying the category. By the user terminal device 30 displaying an image indicating the processed state on the display device, the user can select the processing state of the image while viewing the processed state. Therefore, the user can select an appropriate processing state, and generate an appropriate learning model according to the application. Therefore, the estimation accuracy of the learning model is improved by using the learning model of the present example embodiment.

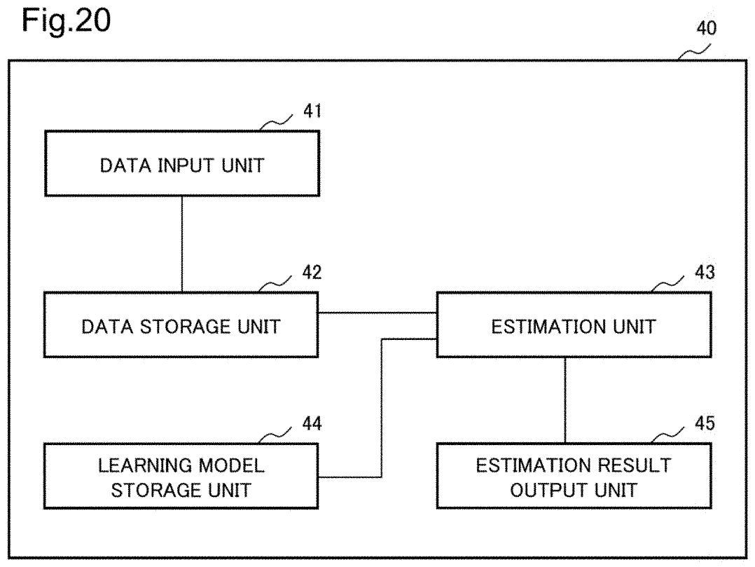

The learning model generated by machine learning in the second example embodiment and the third example embodiment can be used as a learning model for estimating the classification of the category of the input data in the estimation device as illustrated in FIG. 20. FIG. 20 is a view illustrating the configuration of an estimation device 40. The estimation device 40 in FIG. 20 is a device that estimates data to be input using the learning model generated by machine learning in the second example embodiment and third example embodiment. Hereinafter, a case of an estimation device that estimates the classification of an object on an image will be described as an example.

The estimation device 40 in FIG. 20 includes a data input unit 41, a data storage unit 42, an estimation unit 43, a learning model storage unit 44, and an estimation result output unit 45.

The data input unit 41 receives input of image data for estimating the classification of an object on an image. The data input unit 41 stores the input image data in the data storage unit 42.

The data storage unit 42 stores the image data input to the data input unit 41.

The estimation unit 43 estimates the classification of the object photographed in the image data using the learning model stored in the learning model storage unit 44. The learning model used in the estimation device 40 is a learning model similar to the learning models generated in the second example embodiment and the third example embodiment.

The learning model storage unit 44 stores a learned model by machine learning, that is, a learning model. The learning model is input to the estimation device 40 by the worker. The learning model may be acquired from another server via a network.

The estimation result output unit 45 sends the estimation result of the classification on the image by the estimation unit 43 to the display device. The estimation result output unit 45 may transmit the estimation result by the estimation unit 43 to another terminal device via the network.

The estimation device 40 in FIG. 20 may be provided as a part of the learning system of the second example embodiment and the third example embodiment. In such a configuration, input of the image data to the estimation device 40 and acquisition of the estimation result may be performed using a terminal device or a user terminal device. In the above description, the learning model for estimating the classification of an object on an image has been described, but the estimation device 40 can also be used for estimation of classification by a learning model performing language analysis and time-series signal analysis.

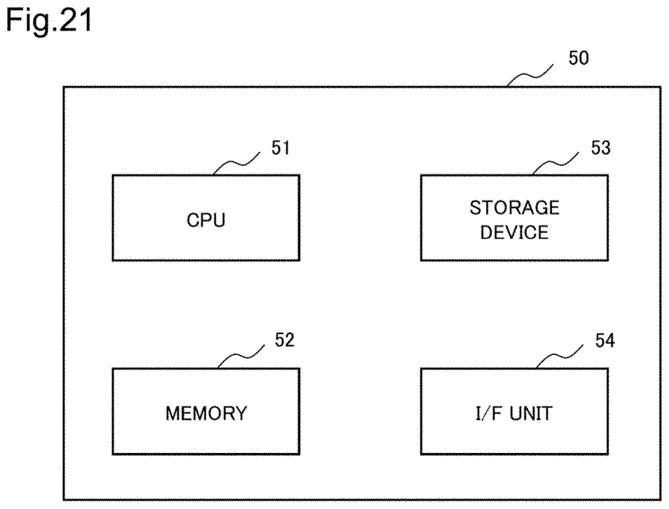

Each processing in the learning device of the first example embodiment, the learning device of the second example embodiment, and the learning device of the third example embodiment can be performed by a computer executing a computer program. FIG. 21 illustrates an example of the configuration of a computer 50 that executes a computer program for performing each processing in the learning device. The computer 50 includes a CPU 51, a memory 52, a storage device 53, and an interface (I/F) unit 54. The terminal devices of the second example embodiment and third example embodiment, the user terminal of the third example embodiment, and the estimation device of the fourth example embodiment have also similar configurations.

The CPU 51 reads and executes a computer program for performing each processing from the storage device 53. An arithmetic processing unit that executes the computer program may be configured by combination of a CPU and a GPU instead of the CPU 51. The memory 52 includes a dynamic random access memory (DRAM), and temporarily stores a computer program executed by the CPU 51 and data being processed. The storage device 53 stores a computer program executed by the CPU 51. The storage device 53 includes, for example, a nonvolatile semiconductor storage device. As the storage device 53, another storage device such as a hard disk drive may be used. The I/F unit 54 is an interface that inputs and outputs data to and from another unit of the learning system, a terminal of a network of a management target, and the like. The computer 50 may further include a communication module that communicates with another information processing device via a communication network.

The computer program performed in each processing can be stored in a recording medium and distributed. As the recording medium, for example, a data recording magnetic tape or a magnetic disk such as a hard disk can be used. As the recording medium, an optical disk such as a compact disc read only memory (CD-ROM) can also be used. A nonvolatile semiconductor storage device may be used as a recording medium.

A part or the entirety of the above example embodiments can be described as the following supplementary notes, but are not limited to the following.

(Supplementary Note 1)

A learning device including:

a learning means configured to execute machine learning based on first training data and generate a learning model for classifying a category of the first training data;

an attention part detection means configured to detect an attention part on the first training data to which the learning model pays attention when a category of the first training data is classified using the learning model; and

a data generation means configured to generate second training data in which the attention part is processed based on a rate at which the attention part matches a predetermined attention determination part to which attention is to be paid.

(Supplementary Note 2)

The learning device according to supplementary note 1, in which the data generation means generates the second training data by processing the attention part in such a manner that contribution of the attention part to the classification decreases in a case where a rate at which the attention part matches the attention determination part is lower than a predetermined value.

(Supplementary Note 3)

The learning device according to supplementary note 1 or 2, in which

the data generation means includes
a matching detection means configured to detect a rate at which the attention determination part matches the attention part when a category is classified using the learning model, and
a data processing means configured to process, in a case where the matching rate is lower than a predetermined value, the attention part to prevent the learning model from classifying a category, and generate the second training data by processing.

(Supplementary Note 4)

The learning device according to any of supplementary notes 1 to 3, in which the learning means updates the learning model by relearning using the second training data.

(Supplementary Note 5)

The learning device according to any of supplementary notes 1 to 4, in which the learning means determines that generation of the learning model ends when estimation accuracy of the learning model meets a predetermined criterion.

(Supplementary Note 6)

The learning device according to any of supplementary notes 1 to 5 further including a training data storage means configured to store, in association with the first training data, information on a part in which a target whose category is classified exists on the data as information on an attention part.

(Supplementary Note 7)

The learning device according to any of supplementary notes 1 to 6, in which when generating the second training data, the data generation means generates the second training data subjected to processing based on a plurality of pieces of different processing content.

(Supplementary Note 8)

The learning device according to any of supplementary notes 1 to 7, in which

the learning means executes machine learning using the first training data associated with information indicating a region on an image where a target whose category is classified exists as information on the attention determination part, and generates a learning model for estimating classification of an object on the image, and

the data generation means generates the second training data by performing processing in such a manner that the attention part on the image does not contribute to classification of a category in a case where a rate at which the attention part to which attention is paid when the category is classified on the image using the learning model matches the attention determination part is lower than a predetermined value.

(Supplementary Note 9)

The learning device according to supplementary note 8, in which the data generation means calculates, as the matching rate, a ratio of a first number of pixels to a second number of pixels, the first number of pixels being a part in which the attention part and the attention determination part overlap each other, the second number of pixels being the attention part to which the learning model pays attention.

(Supplementary Note 10)

The learning device according to supplementary note 8 or 9, in which the data generation means generates the second training data by performing processing of changing at least one of a contrast ratio, luminance, and chromaticity of the image.

(Supplementary Note 11)

A learning method including:

executing machine learning based on first training data and generating a learning model for classifying a category of the first training data;

detecting an attention part on the first training data to which the learning model pays attention when a category of the first training data is classified using the learning model; and

generating second training data in which the attention part is processed based on a rate at which the attention part matches a predetermined attention determination part to which attention is to be paid.

(Supplementary Note 12)

The learning method according to supplementary note 11, further including generating the second training data by processing the attention part in such a manner that contribution of the attention part to the classification decreases in a case where a rate at which the attention part matches the attention determination part is lower than a predetermined value.

(Supplementary Note 13)

The learning method according to supplementary note 11 or 12, further including:

detecting a rate at which the attention determination part matches the attention part when a category is classified using the learning model; and

in a case where the matching rate is lower than a predetermined value, processing the attention part to prevent the learning model from classifying a category, and generating the second training data by processing.

(Supplementary Note 14)

The learning method according to any of supplementary notes 11 to 13, further including updating the learning model by relearning using the second training data.

(Supplementary Note 15)

The learning method according to any of supplementary notes 11 to 14, further including determining that generation of the learning model ends when estimation accuracy of the learning model meets a predetermined criterion.

(Supplementary Note 16)

The learning method according to any of supplementary notes 11 to 15, further including storing information on a part in which a target whose category is classified exists on the data, in association with the first training data, as information on an attention part.

(Supplementary Note 17)

The learning method according to any of supplementary notes 11 to 16, further including generating, when generating the second training data, the second training data subjected to processing based on a plurality of pieces of different processing content.

(Supplementary Note 18)

The learning method according to any of supplementary notes 11 to 17, further including:

executing machine learning using the first training data in which information indicating a region on an image where a target whose category is classified exists as information on the attention determination part is associated with image data, and generating a learning model for estimating classification of an object on the image; and

generating the second training data by performing processing in such a manner that the attention part on the image does not contribute to classification of a category in a case where a rate at which the attention part to which attention is paid when the category is classified on the image using the learning model matches the attention determination part is lower than a predetermined value.

(Supplementary Note 19)

The learning method according to supplementary note 18, further including calculating, as the matching rate, a ratio of a first number of pixels to a second number of pixels, the first number of pixels being a part in which the attention part and the attention determination part overlap each other, the second number of pixels being a part to which the learning model pays attention.

(Supplementary Note 20)

The learning method according to supplementary note 18 or 19, further including generating the second training data by performing processing of changing at least one of a contrast ratio, luminance, and chromaticity of the image.

(Supplementary Note 21)

A recording medium recording a computer program for causing a computer to execute:

processing of executing machine learning based on the first training data and generating a learning model for classifying a category of first training data;

processing of detecting an attention part on the first training data to which the learning model pays attention when a category of the first training data is classified using the learning model; and

processing of generating second training data in which the attention part is processed based on a rate at which the attention part matches a predetermined attention determination part to which attention is to be paid.

(Supplementary Note 22)

The recording medium according to supplementary note 21, recording a computer program for causing a computer to execute processing of generating the second training data by processing the attention part in such a manner that contribution of the attention part to the classification decreases in a case where a rate at which the attention part matches the attention determination part is lower than a predetermined value.

The present invention has been particularly shown and described with reference to the above-described example embodiments as exemplary examples. However, the present invention is not limited to the above-described example embodiments. It will be understood by those of ordinary skill in the art that various aspects may be made therein without departing from the spirit and scope of the present invention as defined by the claims.

### REFERENCE SIGNS LIST

1 learning unit
2 attention part detection unit
3 data generation unit
10 learning device
11 training data input unit
12 training data storage unit
13 learning unit
14 learning model storage unit
15 attention part detection unit
16 matching detection unit
17 data processing unit
20 learning device
21 data processing unit
22 data processing control unit
23 user terminal communication unit
30 user terminal device
31 candidate data reception unit
32 user terminal control unit
33 candidate data output unit
34 selection result input unit
35 selection result transmission unit
40 estimation device
41 data input unit
42 data storage unit
43 estimation unit
44 learning model storage unit
45 estimation result output unit
50 computer
51 CPU
52 memory
53 storage device
54 I/F unit
100 terminal device
101 training data generation unit
102 control unit
103 data transmission and reception unit
104 input unit
105 output unit

What is claimed is:

1. A learning device comprising:
at least one memory storing instructions; and
at least one processor configured to access the at least one memory and execute the instructions to:
execute machine learning based on first training data and generate a learning model for classifying a category of the first training data;
detect an attention part on the first training data to which the learning model pays attention when a category of the first training data is classified using the learning model; and
generate second training data in which the attention part is processed based on a rate at which the attention part matches a predetermined attention determination part to which attention is to be paid.

2. The learning device according to claim 1, wherein
the at least one processor is further configured to execute the instructions to:
generate the second training data by processing the attention part in such a manner that contribution of the attention part to the classification decreases in a case where a rate at which the attention part matches the attention determination part is lower than a predetermined value.

3. The learning device according to claim 1, wherein
the at least one processor is further configured to execute the instructions to:
detect a rate at which the attention determination part matches the attention part when a category is classified using the learning model, and
process, in a case where the matching rate is lower than a predetermined value, the attention part to prevent the learning model from classifying a category, and generate the second training data by processing.

4. The learning device according to claim 1, wherein
the at least one processor is further configured to execute the instructions to:
update the learning model by relearning using the second training data.

5. The learning device according to claim 1, wherein
the at least one processor is further configured to execute the instructions to:
determine that generation of the learning model ends when estimation accuracy of the learning model meets a predetermined criterion.

6. The learning device according to claim 1, wherein
the at least one processor is further configured to execute the instructions to:
store, in association with the first training data, information on a part in which a target whose category is classified exists on the first training data as information on an attention part.

7. The learning device according to claim 1, wherein
the at least one processor is further configured to execute the instructions to:
generate the second training data subjected to processing based on a plurality of pieces of different processing content.

8. The learning device according to claim 1, wherein
the at least one processor is further configured to execute the instructions to:
execute machine learning using the first training data associated with information indicating a region on an image where a target whose category is classified exists as information on the attention determination part;
estimate classification of an object on the image, and
generate the second training data by performing processing in such a manner that the attention part on the image does not contribute to classification of a category in a case where a rate at which the attention part to which attention is paid when the category is classified on the image using the learning model matches the attention determination part is lower than a predetermined value.

9. The learning device according to claim 8, wherein
the at least one processor is further configured to execute the instructions to:
calculate, as the matching rate, a ratio of a first number of pixels to a second number of pixels, the first number of pixels being a part in which the attention part and the attention determination part overlap each other, the second number of pixels being the attention part to which the learning model pays attention.

10. The learning device according to claim 8, wherein
the at least one processor is further configured to execute the instructions to:
generate the second training data by performing processing of changing at least one of a contrast ratio, luminance, and chromaticity of the image.

11. A learning method comprising:
executing machine learning based on first training data and generating a learning model for classifying a category of the first training data;
detecting an attention part on the first training data to which the learning model pays attention when a category of the first training data is classified using the learning model; and
generating second training data in which the attention part is processed based on a rate at which the attention part matches a predetermined attention determination part to which attention is to be paid.

12. The learning method according to claim 11, further comprising generating the second training data by processing the attention part in such a manner that contribution of the attention part to the classification decreases in a case where a rate at which the attention part matches the attention determination part is lower than a predetermined value.

13. The learning method according to claim 11, further comprising:
detecting a rate at which the attention determination part matches the attention part when a category is classified using the learning model; and
in a case where the matching rate is lower than a predetermined value, processing the attention part to prevent the learning model from classifying a category, and generating the second training data by processing.

14. The learning method according to claim 11, further comprising updating the learning model by relearning using the second training data.

15. The learning method according to claim 11, further comprising determining that generation of the learning model ends when estimation accuracy of the learning model meets a predetermined criterion.

16. The learning method according to claim 11, further comprising storing information on a part in which a target whose category is classified exists on the first training data, in association with the first training data, as information on an attention part.

17. The learning method according to claim 11, further comprising generating the second training data subjected to processing based on a plurality of pieces of different processing content.

18. The learning method according to claim 11, further comprising:
executing machine learning using the first training data in which information indicating a region on an image where a target whose category is classified exists as information on the attention determination part is associated with image data, and generating a learning model for estimating classification of an object on the image; and
generating the second training data by performing processing in such a manner that the attention part on the image does not contribute to classification of a category in a case where a rate at which the attention part to which attention is paid when the category is classified on the image using the learning model matches the attention determination part is lower than a predetermined value.

19. The learning method according to claim 18, further comprising calculating, as the matching rate, a ratio of a first number of pixels to a second number of pixels, the first number of pixels being a part in which the attention part and the attention determination part overlap each other, the second number of pixels being the attention part to which the learning model pays attention.

20. (canceled)

21. A non-transitory recording medium recording a computer program for causing a computer to execute:
processing of executing machine learning based on first training data and generating a learning model for classifying a category of the first training data;
processing of detecting an attention part on the first training data to which the learning model pays attention when a category of the first training data is classified using the learning model; and
processing of generating second training data in which the attention part is processed based on a rate at which the attention part matches a predetermined attention determination part to which attention is to be paid.

22. (canceled)
